(19) United States
(12) Patent Application Publication
(10) Pub. No.: US 2025/0312958 A1
(43) Pub. Date: Oct. 9, 2025

(54) APPARATUS AND METHOD FOR EXTRUDING MOLDED ARTICLES

(71) Applicant: PLAEX BUILDING SYSTEMS INC., Hampton (CA)

(72) Inventor: Dustin Bowers, Hampton (CA)

(73) Assignee: PLAEX BUILDING SYSTEMS INC., Hampton, NB (CA)

(21) Appl. No.: 18/865,379

(22) PCT Filed: May 15, 2023
(86) PCT No.: PCT/CA2023/050669

§ 371 Date: Nov. 13, 2024

Related U.S. Application Data
(60) Provisional application No. 63/341,859, filed on May 13, 2022.

(51) Int. Cl. B29C 45/50; B29C 45/74; B29K 105/16; B29K 105/26

(52) U.S. Cl. CPC B29C 45/50; B29C 45/74; B29K 2105/16; B29K 2105/26

(57) ABSTRACT

An injection molding apparatus including a barrel including an inlet in the barrel for receiving a composite mixture, an outlet in the barrel for ejecting the composite mixture to a downstream portion of the apparatus; the barrel further containing a screw wherein the screw includes a first set of flights and a second set of flights downstream from the first set of flights, wherein the first set of flights is located proximate to the inlet and is configured to compress the mixture and the second set of flights is configured to mix the compressed composite mixture without further compressing the mixture.

### FIELD

The present invention relates to an apparatus for extruding mold articles in general, and forming extruded plastic aggregate composite articles, including building and landscaping blocks, in particular.

### BACKGROUND

Conventional extrusion apparatus suffer from one or more drawbacks. Some lack flexibility in terms of being able to produce a variety of different molded products. Others have difficulty in handling viscous and abrasive molding composite material, particularly if the composition of the material is not consistent from one batch to the other. Still others rely on compression of the extrusion material for shear heating but compressive heating increases friction which can result in damage to the extrusion chamber, especially if extrusion material is abrasive.

### SUMMARY

In one aspect, the present disclosure relates to an injection molding apparatus including a barrel including an inlet in the barrel for receiving a molding composite mixture, an outlet in the barrel for ejecting the composite mixture to a downstream portion of the apparatus, the barrel further containing a screw wherein the screw includes a first set of flights and a second set of flights downstream from the first set of flights, wherein the first set of flights is located proximate to the inlet and is configured to compact the composite mixture and the second set of flights is configured to mix the compacted composite mixture without further compacting the compacted composite mixture. The apparatus wherein the spacing of the flights in the first set of flights is greater than the spacing on the second set of flights. The apparatus wherein the pitch of the flights in the first set of flights is greater than the pitch of the flights in the second set of flights. The apparatus the barrel further including fins on the shaft of the screw which impart turbulence the composite mixture moving past the zone of the fins. The apparatus wherein the fins are located proximate a downstream end of the screw. The apparatus further including a mold tooling in communication with the outlet of the barrel and a heat pump system operably connected to the mold tooling to draw heat from the mold tooling and connected to the barrel to impart heat to the barrel, the heat pump system further including a regulator for synchronizing the operation of the heat pump with a molding cycle and an auger cycle of the apparatus. The apparatus wherein the molding tool further including modular components are changing molding pieces to make different mold pieces. The apparatus wherein the cooling circuit of the heat pump system is operated during a molding cycle of the apparatus with the heating circuit of the heat pump system not operating, and wherein the heating circuit is operated during operation of the screw while the cooling circuit is not operated. The apparatus wherein the apparatus further includes a horizontally oriented injection tube aligned in parallel below the horizontally aligned barrel, and a molding chamber, the injection tube comprising multiple inlets and an outlet to the molding chamber, and wherein the barrel is movable in a reciprocating fashion along its longitudinal axis whereby the outlet of the barrel can be aligned with one of the inlets of the injection tube to permit filling of the injection tube with composite mixture from the barrel.

In another aspect, the present disclosure relates to a method of molding a piece, including providing a barrel with a screw, introducing a composite mixture in the barrel, compacting the mixture in the upstream end of the screw, inducing turbulence in the downstream end of the screw, whereby mixing the mixture is achieved. The method wherein the composite mixture comprises recycled plastic and recycled crushed aggregate material. The method further including forming a molded piece by injecting downstream of the screw the mixed mixture into a mold and further including extracting heat from the mold to cool the molded piece by using a heat pump system and circulating the extracted heat to the barrel to heat the composite mixture in the barrel, wherein the heat pump system is selectively operated to extract heat only when a molded piece is being formed and heat the barrel only when the screw is operated.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a side view of an apparatus for extruding building blocks and like articles according to an aspect of the present disclosure;

FIG. 2 is a top view of the apparatus of FIG. 1;

FIG. 3 is a front perspective view of the apparatus of FIG. 1 with the mold casing of one product iteration removed;

FIG. 4 is a front perspective view of a rear section of the apparatus of FIG. 1;

FIG. 5 is a rear perspective view of a front section of the apparatus of FIG. 1;

FIG. 6 is a front perspective view of a section of the apparatus of FIG. 1;

FIG. 7 is a side partial section view of a section of the apparatus of FIG. 1;

FIG. 8 is a side partial section view of a front section of the apparatus of FIG. 1 with a mold of one product iteration in an extrusion position;

FIG. 9 is a side partial section view of a front section of the apparatus of FIG. 1 with a mold of one product iteration in a retracted position;

FIG. 10 is an enlarged side partial section of the molding section of the apparatus of FIG. 1, turned approximately 90 degrees;

FIG. 11 is an enlarged side partial section of the molding section of the apparatus of FIG. 1, turned approximately 90 degrees;

FIG. 12 is an enlarged side partial section of the molding section of one product iteration of the apparatus of FIG. 1, turned approximately 90 degrees;

FIG. 13 is an enlarged side partial section of the molding section of one product iteration of the apparatus of FIG. 1, turned approximately 90 degrees;

FIG. 14 is an enlarged side partial section of the molding section of one product iteration of the apparatus of FIG. 1, turned approximately 90 degrees;

FIG. 15 is an enlarged side partial section of the molding section of one product iteration of the apparatus of FIG. 1, turned approximately 90 degrees;

FIG. 16 is a perspective view of an apparatus according to another aspect of the present disclosure;

FIG. 17 is an enlarged partial view of the downstream end of the apparatus of FIG. 16 with the modular mold section of one product iteration in a molding position;

FIG. 18 is an enlarged partial view of the downstream end of the apparatus of FIG. 16 with the modular mold section of one product iteration in disengaged position;

FIG. 19 is an end view of the downstream end of the apparatus of FIG. 17;

FIG. 20 is a perspective view of a molded piece of one product iteration surrounded by an exploded view of components of the mold section of FIG. 17;

FIG. 21 is an end view of the downstream end of the apparatus of FIG. 18;

FIG. 22 is a left side view of the apparatus of FIG. 16;

FIG. 23 is a partial section view of taken along line A-A of FIG. 16;

FIG. 24 is a partial top view of the downstream end of the apparatus of FIG. 16 with the top housing of the mold section of one product iteration removed with the fork frame 560 in a position advanced toward a molded piece of one product iteration;

FIG. 25 is a partial top view of the downstream end of the apparatus of FIG. 16 with the top housing of the mold section of one product iteration removed with the fork frame 560 in a position pulled away from a molded piece of one product iteration;

FIG. 26 is a partial section view along line B-B of FIG. 17;

FIG. 27 is a right side view of the apparatus of FIG. 16;

FIG. 28 is partial section view along line C-C of FIG. 29;

FIG. 29 is a top view of the apparatus of FIG. 16;

FIG. 30 is a partial section view along line D-D of FIG. 16;

FIG. 31 is a partial section view along line A-A of FIG. 16 of a portion of the apparatus;

FIG. 32 is a partial section view along line A-A of FIG. 16;

FIG. 33 is a section view of the auger screw of FIG. 34;

FIG. 34 is a perspective view of an auger screw according to an aspect of the present disclosure; and,

FIG. 35 is an enlarged view of section A of the auger screw of FIG. 35.

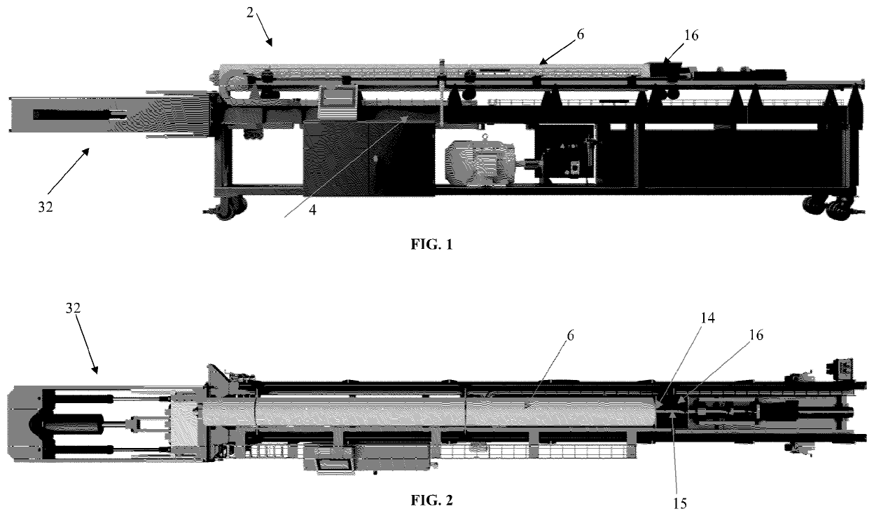

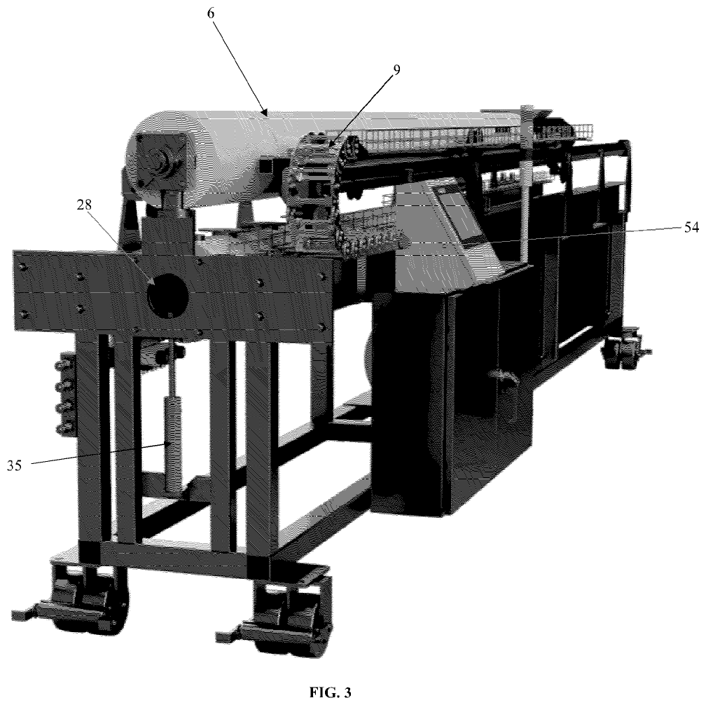

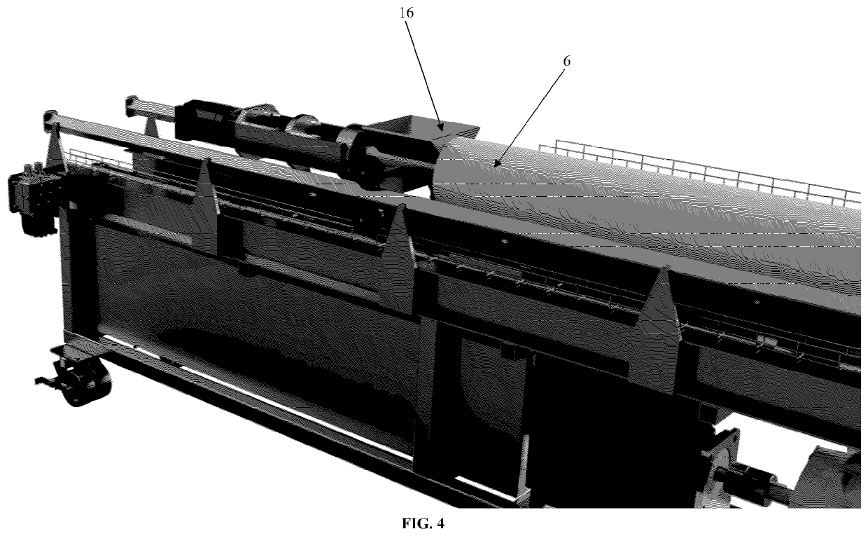

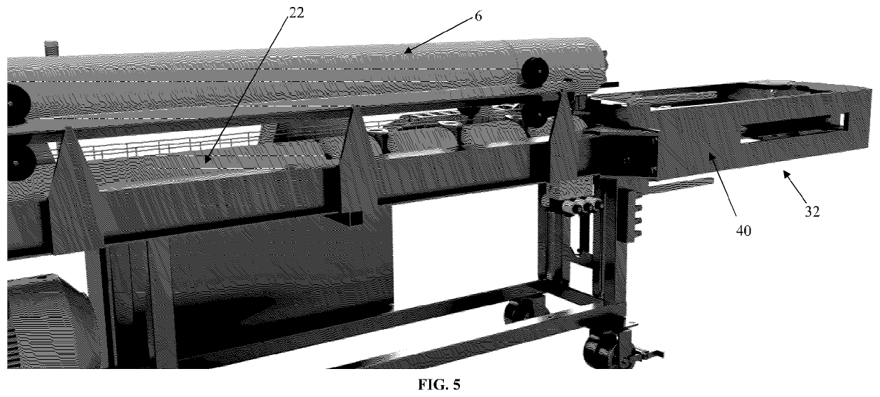

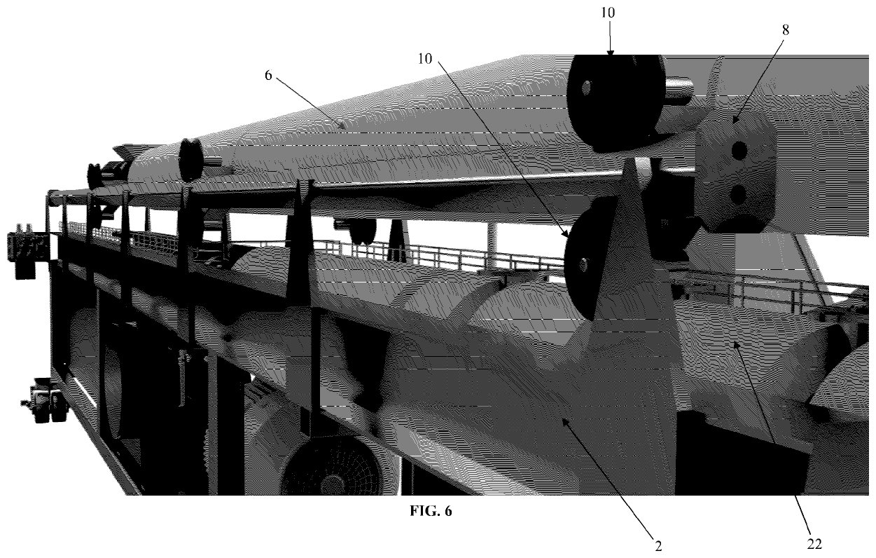

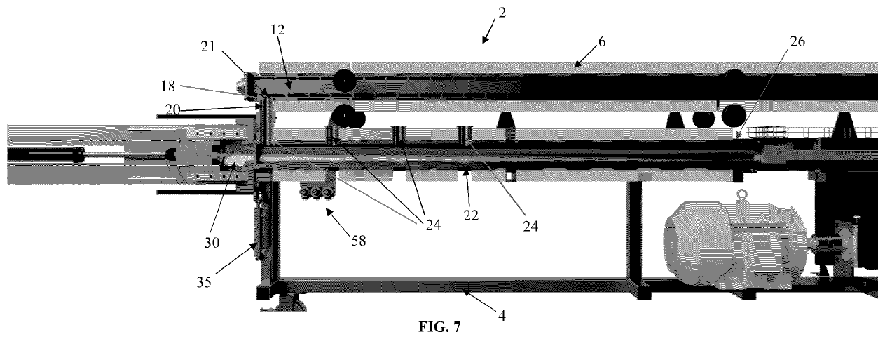

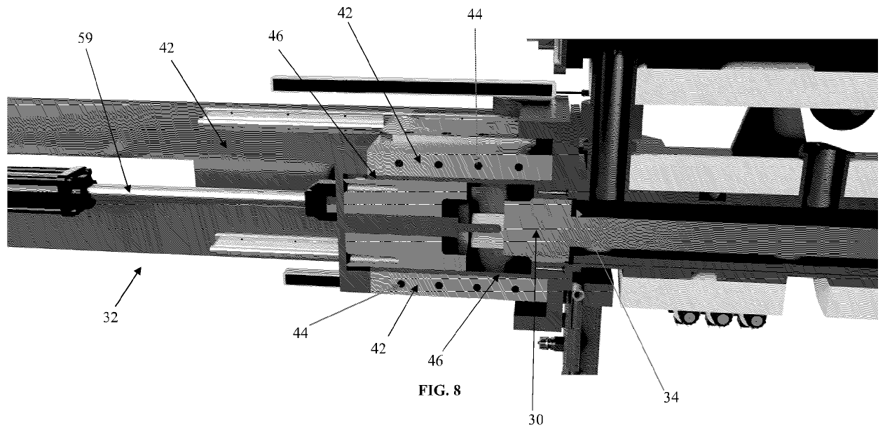

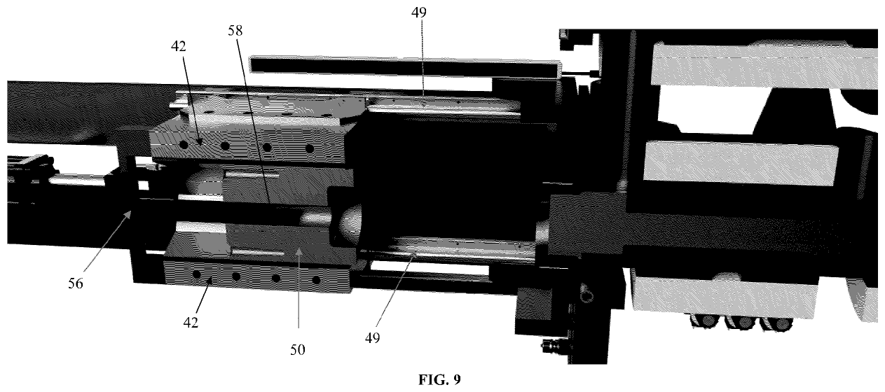

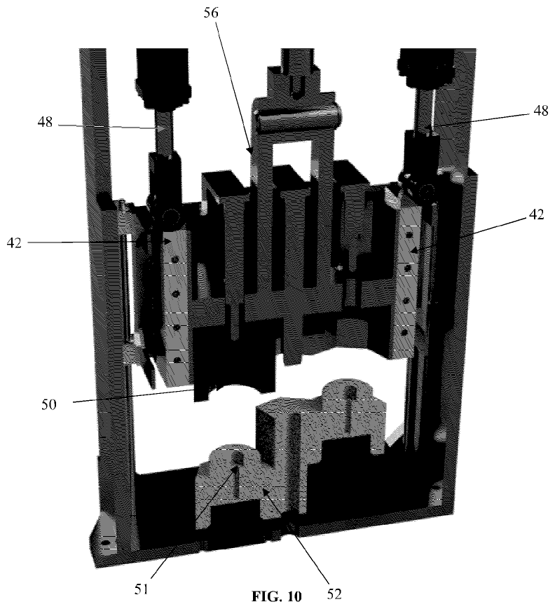

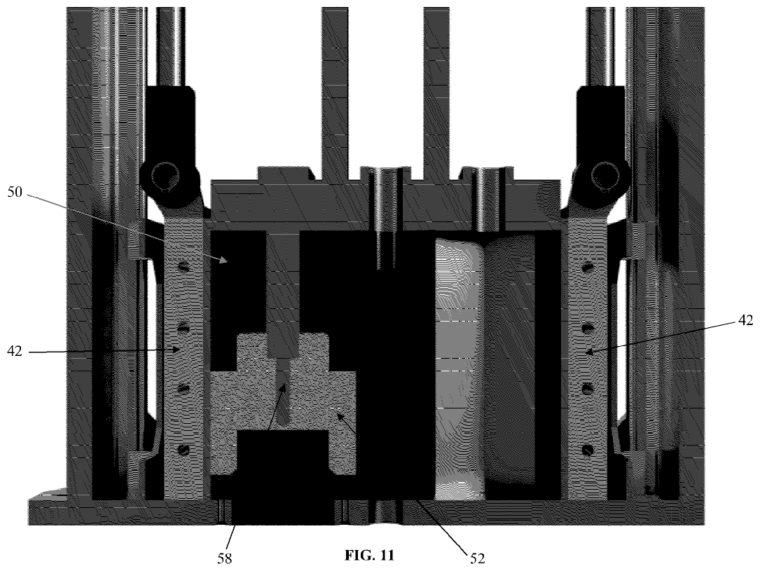

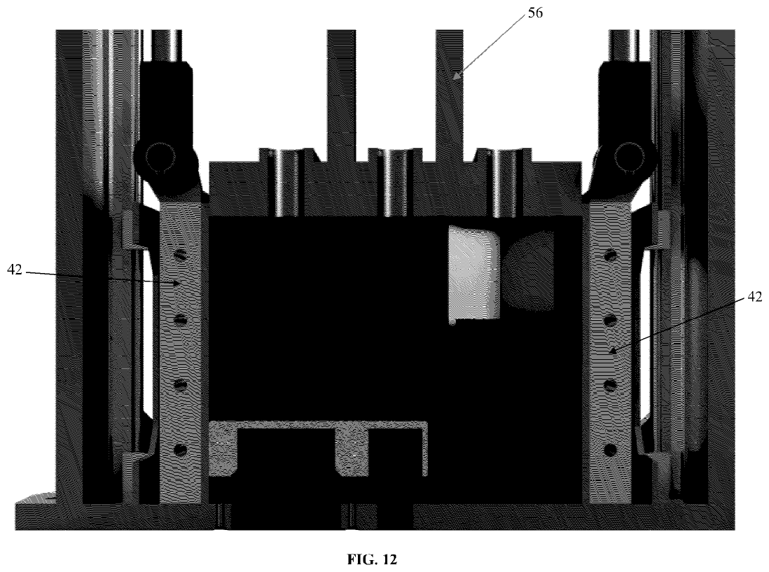

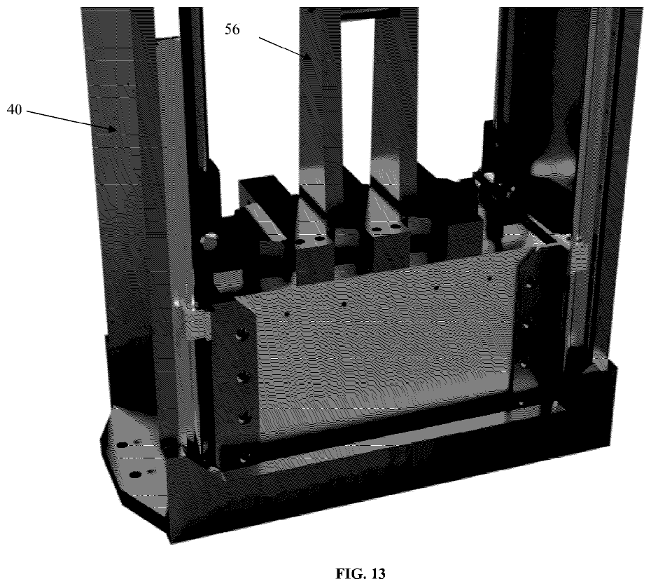

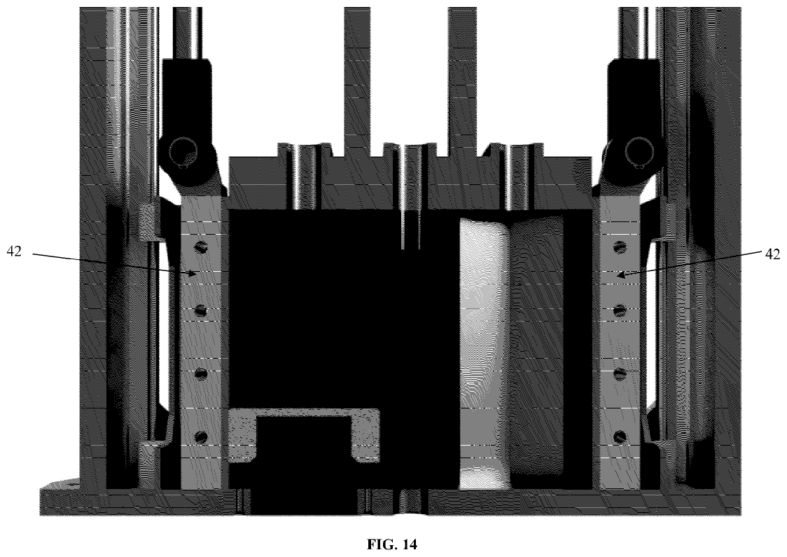

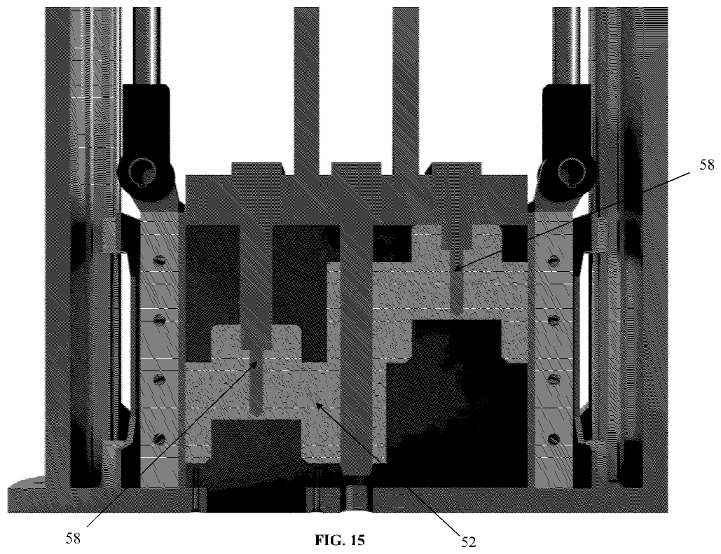

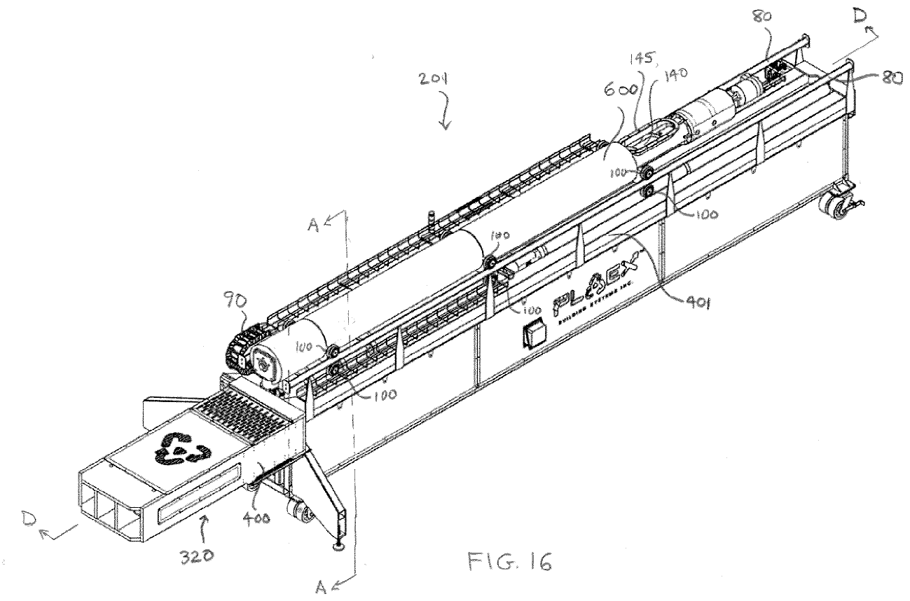

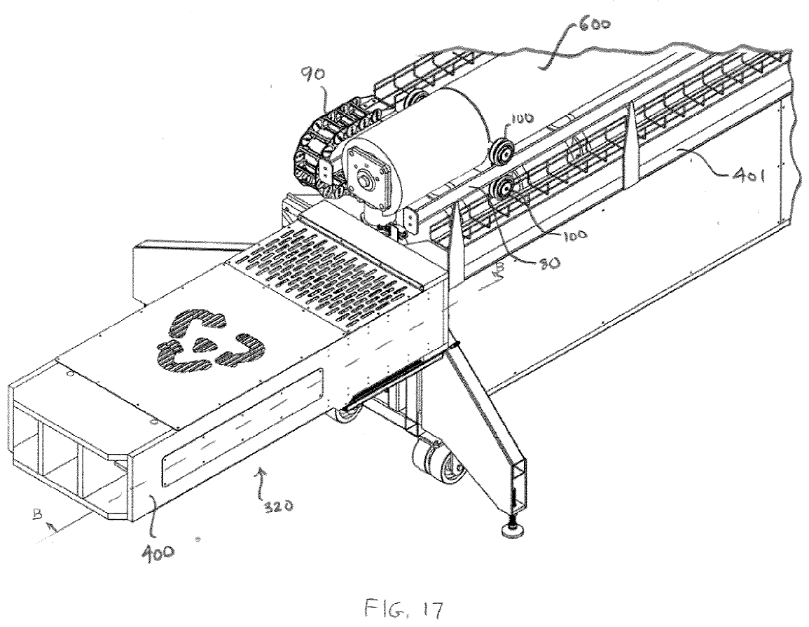

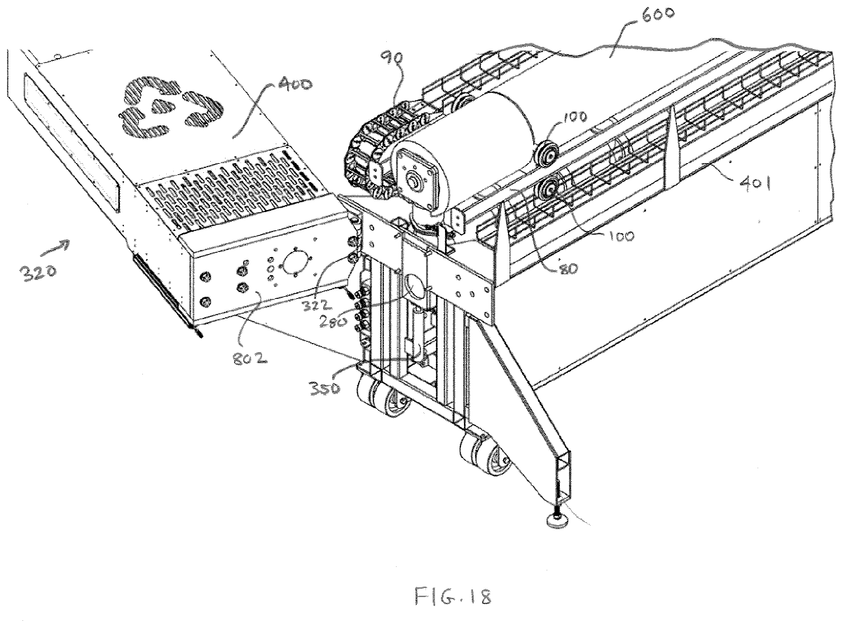

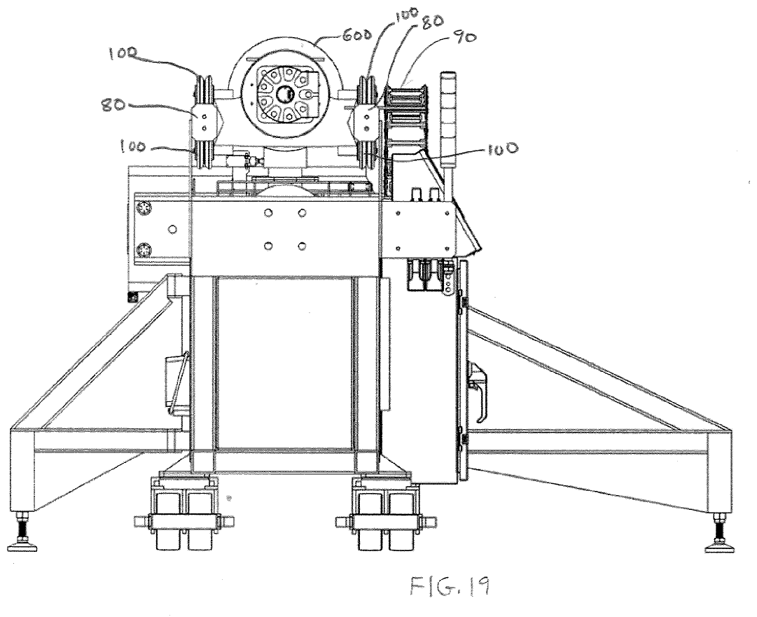

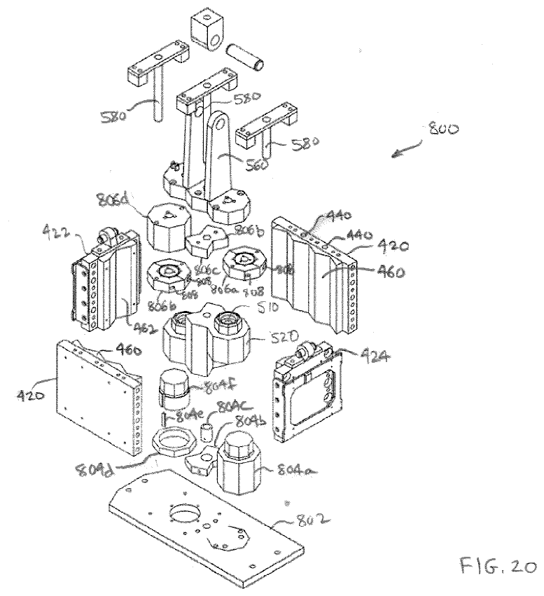

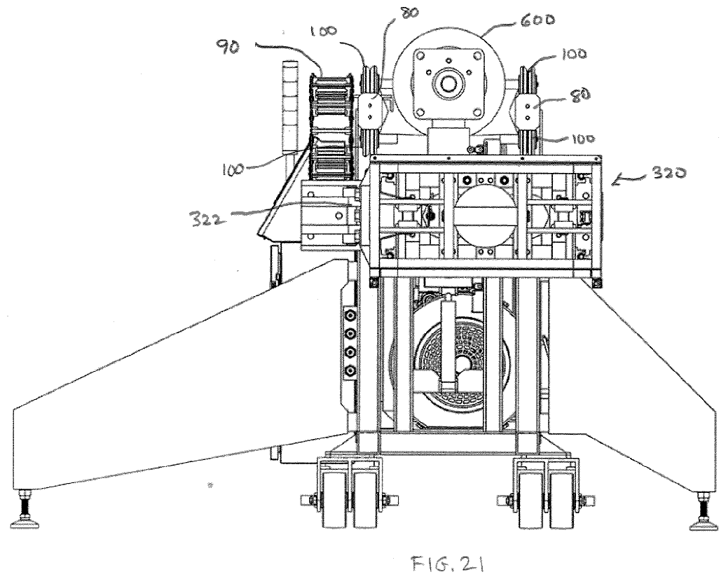

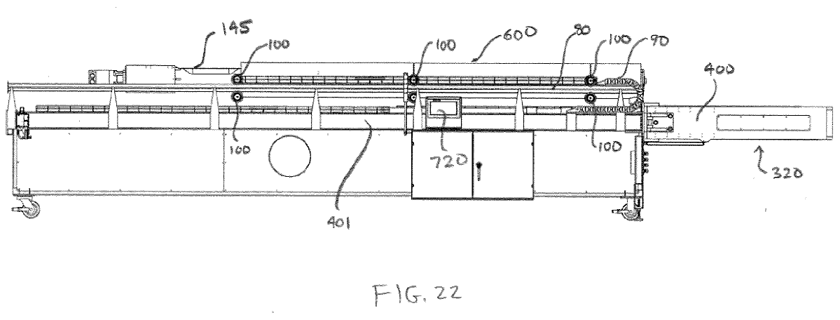

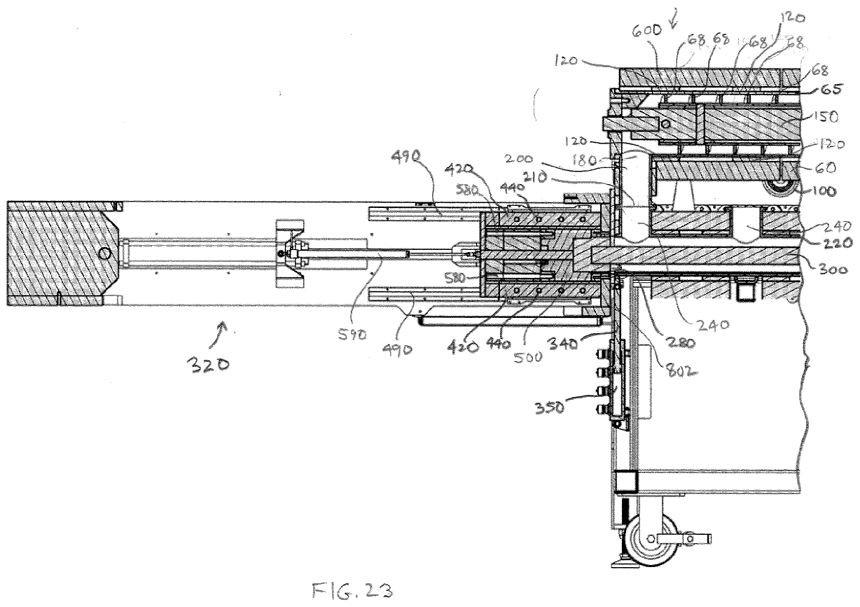

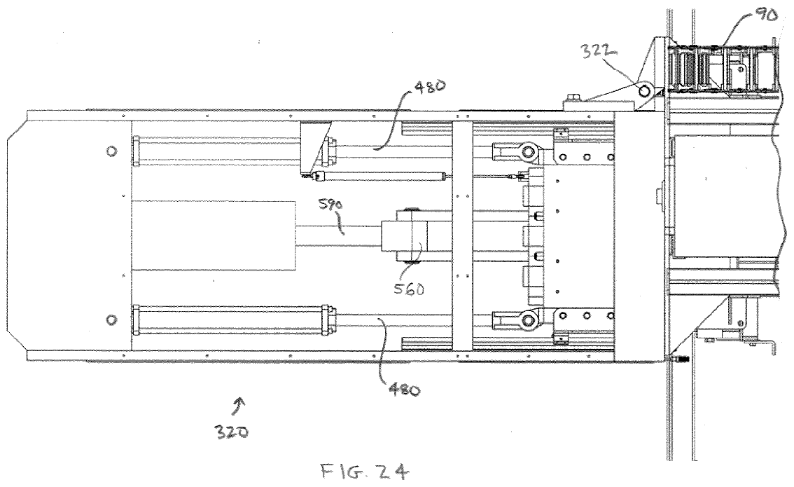

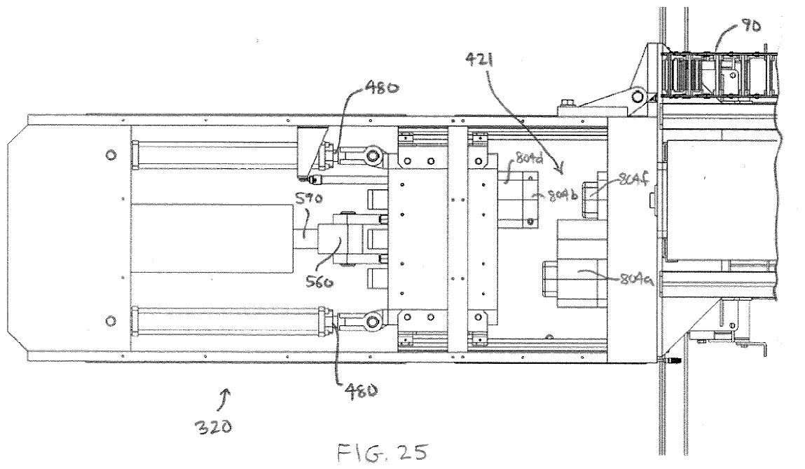

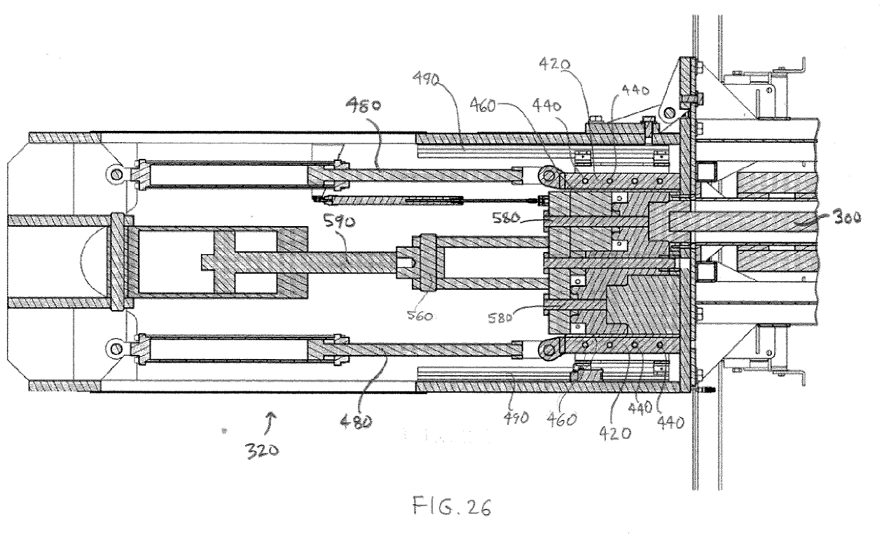

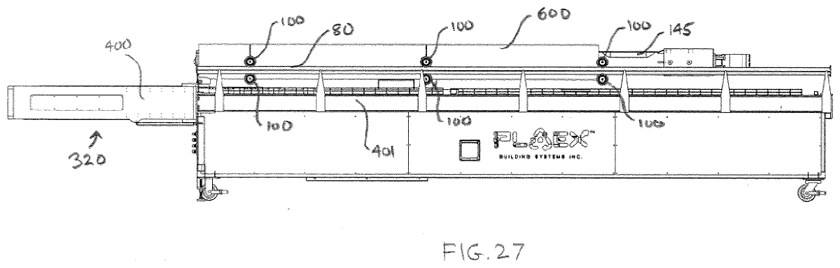

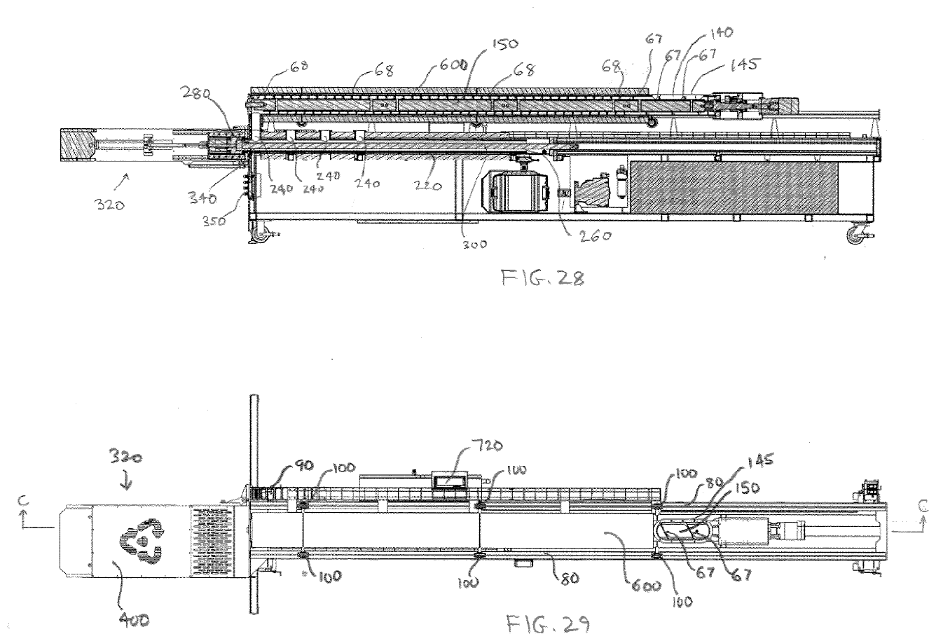

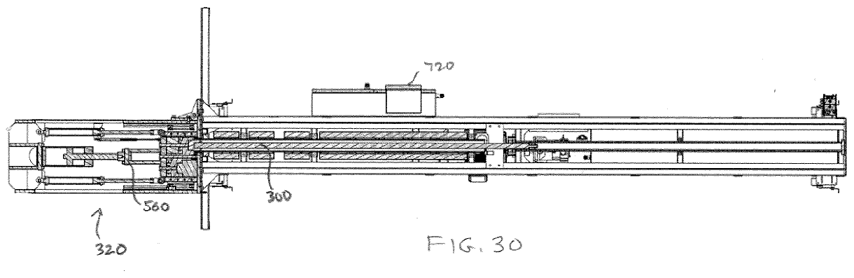

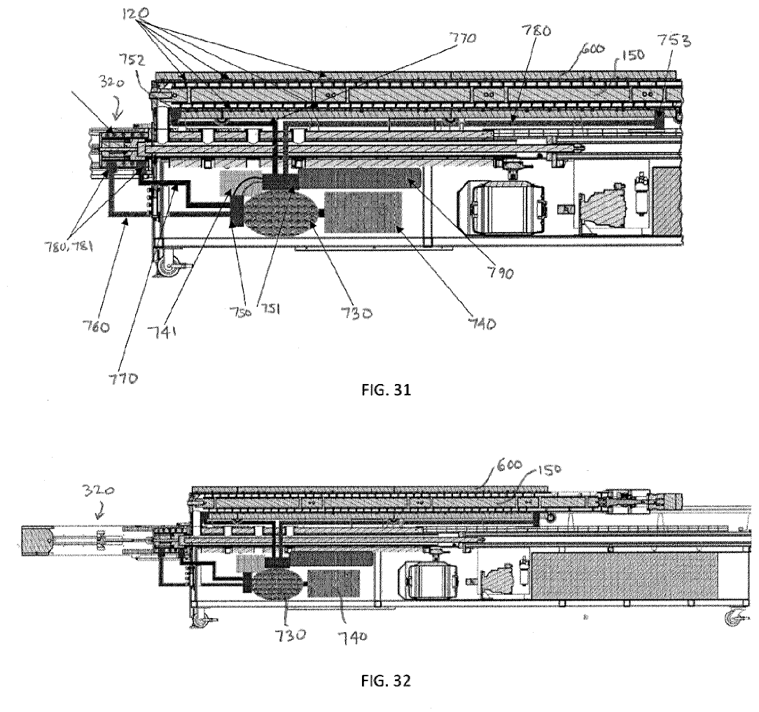

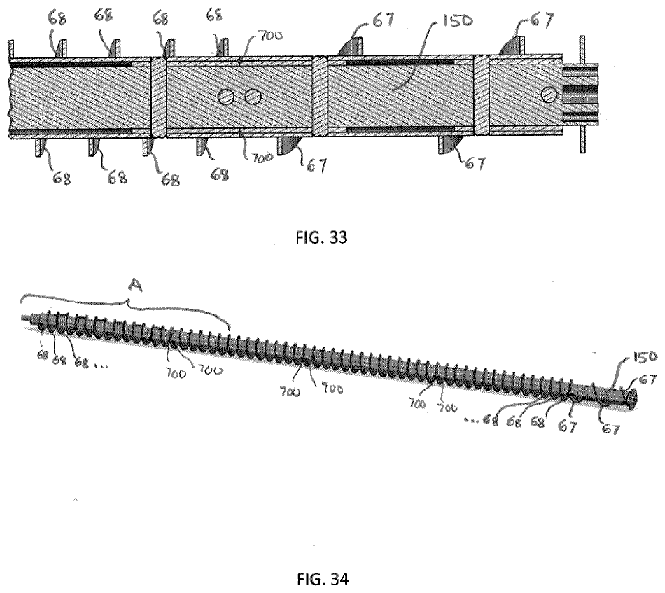

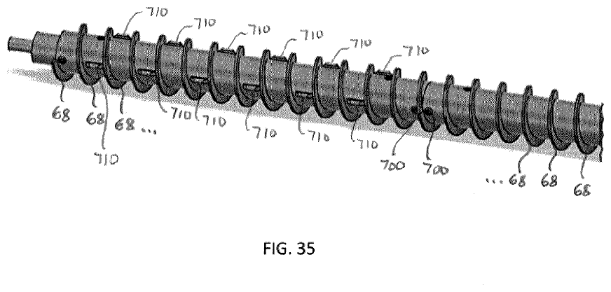

### DETAILED DESCRIPTION

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The present invention, in one embodiment, relates to a modular automated thermal extruder/injector and modular mold system for molding blocks, bricks and panels for building, construction, landscaping walls and the like made from a plastic aggregate composite. In one embodiment, a viscous composite is used as the extruded material. In one embodiment, the abrasive and viscous composite can have the consistency of thick putty. In another embodiment, the apparatus allows for simple automated calibration and production of a range of molded products and parts by swapping parts of a mold or a mold itself (one mold per product type). In another embodiment, the apparatus is configured to auto calibrate once a mold is set and the intended product is selected from a touch screen. The apparatus can also be linked wirelessly to a satellite link for example, to allow for wireless updates, real time feedback data, and new product configurations.

In one embodiment, an apparatus according to the invention indicated generally at 2 includes a main frame 4 and an auger tube 6 mounted on rails 8 on the top of the frame 2. Wheels 10 contacting the rails 8 guide the movement of the auger tube 6 along the rails 8. Cable protector cage 9 protects cables as the auger tube 6 moves on the rails 8. Heating elements 12 for example band heaters, are wrapped around the auger tube 6 at regular intervals. The heating elements 12 heat the auger tube 6 to heat an injection material. In one embodiment, the injection material is a mixture of recycled plastic and recycled particulate. In another embodiment, the heating elements 12 may be supplemented or replaced by high pressure lines allowing for the implementation of a heat pump system in order to greatly increase energy efficiency.

The auger tube 6 has an inlet 14 at a rear end of the auger tube 6 through which passes an auger 15 along the longitudinal axis of the auger tube 6. The auger 15 passes through a hopper 16 by the inlet 14. The auger tube 6 has an outlet 18 at the bottom of the auger tube 6. A fill-tube 20 is connected to the outlet 18. A gate 21 is operable to open and close outlet 18.

An injection tube 22 is mounted on the frame 4 below the auger tube 6. The injection tube 22 includes four inlets 24 in the top of the auger tube 6 near the front end of the auger tube 6. The four inlets 24 serve as filling or injection points. In other embodiments, the auger tube 6 can have more than four inlets or fewer than four inlets. In operation, the auger tube 6 is moved along the rails 8 to register the fill-tube 20 with one of the four inlets 24 of the injection tube 6. A particular auger tube inlet 24 is selected according to the size of piece such as 52 being produced. In one embodiment, an inlet tube 24 is selected where the distance of the inlet tube 24 from the end of the injection tube 22 is approximately ⅓ of the length of the injector ram depth for the volume of material needed for the particular extruded article being produced. The position of the auger tube inlet 24 selected assists in reducing the amount of pressure required to inject injection material into the injection tube 22 prior to extrusion, thus reducing stress on the main auger 15. In one embodiment, the apparatus 2 can be programmed with the amount of extrusion material being injected into injection tube 22.

The injection tube 22 also includes an inlet 26 at the rear end of the injection tube 22 and an outlet 28 at the front end of the injection tube 22. The inlet 26 at the rear end of the injection tube 22 receives a ram 30 for sliding movement along the longitudinal axis of the injection tube 22. Ram 30 is movable from a retracted position away from injection tube inlet 24 selected, to an extrusion position whereby the ram 30 contacts extrusion material in injection tube 22 and moves toward the injection tube outlet 28 to push extrusion material into a modular mold section indicated generally at 32 attached to the outlet 28 of the injection tube 22 at the front end of the injection tube 22. A gate 34 is located at the injection tube outlet 28. The gate 34 is driven by piston 35 and is in a closed position when the composite material is being extruded into the injection tube 22, and in an open position when composite material is being injected into modular mold section 32.

Modular mold section 32 includes an outer casing frame 40, a mold chamber which is comprised of machined metal plates 42, preferably of aluminum to facilitate heat transfer. Conduits 44 are located in plates 42 through which a cooling fluids or gasses can be circulated to cool the plates 42. A layer 46 of hardened steel is located on the inside surface of each plate 42. The plates 42 are connected to side pistons 48 which when actuated move the plates 42 toward or away from the gate 34 along fixed rail tracks 49. A fork frame 56 with one or more pins 58 is attached to the mold chamber walls 42. Pin 58 produces a hole 51 in piece 52 being molded.

Mold blocking set 50 is located at one end of the mold chamber between plates 42 and is comprised of several interchangeable parts allowing reconfiguration of the mould to produce multiple iterations of parts. Mold blocking set 50 forms the top of a piece 52 being molded. Mold blocking set 50 is connected to a central piston 59 which when actuated moves the metal plates toward or away from gate 34. After a piece such as piece 52 is molded, mold blocking set 50 and plates 42 are retracted by pistons 59 and 48 to open mold chamber such that piece 52 can then be ejected by piston 59 pushing mould blocking set 50 towards gate 34 with mold walls 42 in the open position away from gate 34 thereby ejecting the newly moulded part 52 as both parts of the mould cycle in and out. In one embodiment, piece 52 is moved by being dropped onto a conveyor from the mold chamber when in the open position.

In one embodiment, individual mold blocks for sets like 50 can include an RFID chip or other similar wireless or mechanical information transmission system which can be read by the apparatus to then configure and operate the components of the apparatus to mold the piece according to the mold set that is installed as a smart self calibrating system. Apparatus 2 is controlled by controller 54. Electrical power can be provided from a variety of sources such as a conventional power grid or solar power, the later making it possible to operate the apparatus 2 in remote locations. Hydraulic power is supplied through hydraulic connectors indicated generally at 58 to which hydraulic hoses can be attached. Hydraulic power is used to for example operate the pistons 48 and 59 and drive the auger 15.

In operation, in one embodiment, recycled plastic pieces and recycled aggregate are introduced into hopper 16 and are then carried and condensed by auger 15 in auger chamber 6 while the auger chamber 6 is heated by heating elements 12. Gate 34 is closed and the auger chamber is slid along rails 8 until fill-tube 20 lines up with the appropriate inlet 24 of the injection tube 22 that is appropriate for the volume of the piece being molded. Gate 21 is opened and injection material is pushed through fill-tube 20 by the compressive pressure of auger 15. Once the injection chamber contains a suitable amount of injection material for piece 52 being molded, the gate 34 is opened, ram 30 is actuated to move toward gate 34 and injection material is injected into mold chamber. Ram 30 then retracts, the mold chamber assembly opens up and newly molded piece 52 can be ejected.

In another embodiment, an apparatus according to the invention indicated generally at 201 includes a main frame 401 and an auger tube 600 mounted on rails 80 on the top of frame 401. Wheels 100 contacting the rails 80 guide the movement of the auger tube 60 along the rails 80. Cable protector 90 moves with auger tube 60. Auger tube 600 is an insulation layer. Housed within auger tube 60 is barrel 65. Barrel 65 houses auger screw 150. Heating elements 120, for example band heaters, are wrapped around barrel 65 at regular intervals. The heating elements 120 heat the barrel 65 to heat a composite mix in the barrel. The heating elements 120 may be supplemented or replaced by high pressure lines allowing for the implementation of a heat pump system in order to greatly increase energy efficiency. In one embodiment, the injection material is a mixture of recycled plastic and recycled aggregate.

Auger tube 600 has an inlet 140 and barrel 65 has an inlet hopper flange 145 at an upstream end of barrel 65. Auger screw 150 includes auger flights 67 proximate inlet 140 which are more widely spaced apart and are configured to compact a composite mix (for example a fluffy shredded plastic and aggregate material mix) to a consistent material density in barrel 65 proximate to inlet 140. In one embodiment, barrel 65 is twelve feet in length and fights 67 when rotating compress injection material in a two-foot section of barrel 65 downstream of inlet 140. A series of auger flights 68 (not all auger flights 68 are individually labelled in the figures but the repeating series of flights 68 are indicated using dots . . . ) downstream of auger flights 67 are more closely spaced than auger flights 67 and are configured to not apply compactive or compressive force to composite material in barrel 65. The present inventor has discovered that an auger screw configuration including a series of auger flights having a first spacing and pitch followed by a series of auger flights have a second spacing and pitch, where the first pitch and spacing are greater than the second pitch and spacing, is conducive to achieving consistent density an injection mold material, such as composite mixtures described in this specification, which are abrasive.

In one embodiment, auger screw 150 is made in sections which are joined by connectors 700. This permits the auger screw to be disassembled into sections for shipping for example, or to replace sections if they have worn out or if a section with a flights of a different pitch and/or spacing is desired. In some embodiments, the screw sections are up to four feet in length.

In another embodiment, auger screw 150 includes fins 710. The present inventor has discovered that the inclusion of fins 710 on the shaft of the auger screw 150 creates turbulence in the composite mixture in barrel 65 when auger screw 150 rotates. In some embodiments, fins 710 can be welded or bolted to the surface of auger screw 150. In one embodiment, fins 710 are located in the last third section of the auger screw 150 at the downstream end.

Barrel 65 has an outlet 180 at the bottom of barrel 65. A fill-tube 200 is connected to outlet 180. A gate 210 is operable to open and close outlet 180.

An injection tube 220 is mounted on the frame 400 below the auger tube 600. The injection tube 220 includes four inlets 240 in the top of injection tube 220 near the front end (downstream end) indicated generally at 62 of the auger tube 600. The four inlets 240 serve as filling or injection points. In other embodiments, the injection tube 220 can have more than four inlets 240 or fewer than four inlets 240. In operation, the auger tube 600 is moved along rails 80 to register fill-tube 200 with one of the four inlets 240 of injection tube 220. Auger tube 600 can be driven by a motor (not shown) or moved manually. A controller can indicate the desired position of auger tube 600 on display 720. A particular inlet 240 is selected according to the size of piece 52 being produced. In one embodiment, an inlet tube 240 is selected where the distance of the inlet tube 240 from the end of the injection tube 220 is approximately ⅓ of the length of the injection chamber ram depth needed for the volume of the extruded article being produced. The position of the inlet 240 selected assists in reducing the amount of pressure required to extrude composite material into the injection tube 220 prior to injection. In one embodiment, the apparatus 201 can be programmed with the amount of extrusion material being injected into injection tube 220.

Injection tube 220 also includes an inlet 260 at the rear end of injection tube 220 and an outlet 280 at the front end of the injection tube 220. Inlet 260 at the rear end of injection tube 220 receives a ram 300 for sliding movement along the longitudinal axis of the injection tube 220. Ram 300 is movable from a retracted position away from injection tube inlets 240, to an extrusion position whereby ram 300 contacts extrusion material in injection tube 220 and moves toward the injection tube outlet 280 to push composite material into a modular mold section indicated generally at 320 attached to the outlet 280 of injection tube 220 at the front end of the injection tube 220. Modular mold section 320 can be hinged open from the main unit 201 with hinge 322. A gate 340 is located at the injection tube outlet 280. The gate 340 is driven by piston 350 and is in a closed position when composite material is being extruded into the injection tube 220, and in an open position when composite material is being injected into modular mold section 320.

Modular mold section 320 includes an outer casing 400, a mold chamber which includes two metal plates 420 (top and bottom) and end plates 422 and 424, preferably of aluminum to facilitate heat transfer. Conduits 440 are located in plates 420 through which a cooling fluid or gasses can be circulated to cool the plates 420. A layer 460 of hardened steel is located on the inside surface of each plate 420 and a layer of hardened steel 462 is located on the inside surface of end plate 422. The plates 420 and 422 are connected to side pistons 480 which when actuated move the plates 42 and 422 toward or away from the gate 340 along fixed rail tracks 490.

Components 800 of modular mold section 320 include base plate 802, molding bottom pieces 804a-f, molding top pieces 806a-e which can be changed and are selected depending upon the piece 520 being molded. In one embodiment, top pieces 806a and 806b can include embedded bearings 808 which when contacting layers 460 facilitate the gliding of molding pieces along and relative to plates 420. Mold blocking set 500 is located in mold chamber indicated generally at 421 between plates 420 and 422. Mold blocking set 500 forms the top of a piece 520 being molded. Mold blocking set 500 is connected to a central piston 590 which when actuated moves the metal plates toward or away from gate 340. A fork frame 560 with one or more pins 580 is attached to the mold chamber 421. The pins 580 produce the holes 510 in pieces such as 520 being extruded. After piece 520 is molded, blocking set 500 and plates 420 are retracted to open mold chamber such that piece 520 can be ejected. After a piece such as piece 520 is molded, mold blocking set 500 and plates 420 are retracted by piston 590 and 480 to open mold chamber such that piece 520 can then be ejected by piston 590 pushing mold blocking set 500 towards gate 340 with mold walls 420 in the open position away from gate 340 thereby ejecting the newly moulded part 520 as both parts of the mould cycle in and out. In one embodiment, piece 520 is moved by being dropped onto a conveyor from the mold chamber when in the open position.

In operation, in one embodiment, recycled plastic pieces and recycled aggregate are introduced into inlet 140 and are then carried and condensed by auger screw 150 in barrel 65 while the barrel 65 is heated by heating elements 120. Gate 340 is closed and the barrel 65 is slid along rails 80 until fill-tube 200 lines up with the selected inlet 240 of the injection tube 220 that is appropriate for the length of piece being molded. Gate 210 is opened and injection material is pushed through fill-tube 200 by auger screw 150. Once the injection chamber contains a suitable amount of composite material for piece 520 being molded, the gate 340 is opened, ram 300 is actuated to move toward gate 340 and the composite material is injected into mold chamber. Ram 300 then retracts, the mold chamber opens up and newly molded piece 52 can be removed.

In another embodiment, an apparatus according to the present invention includes a heat pump system wherein the heat pump system which extracts heat from the mold chamber 421 via conduits 440 to help cool piece 520 and uses the extracted heat to heat a composite mixture in barrel 65. The heat pump system operates using a pulsing method to increase the amount of heat and amount of cold that is produced by it, wherein there is an increased compression pressure which increases the amount of heat produced on the extrusion end and by contrast increases the amount of cold that can be extracted on the mold end. The heat pump system includes a digitally controlled valve system that can be operated to alternate the heat pump system between compressing and decompressing in time with the cycling of the injection apparatus so while the apparatus is extruding it is building pressure and heat on the compression side, inversely the amount of decompression then available to cool the mold is increased commensurately. This permits reaching higher and lower temperatures than the prior art system described in Chinese Patent Application No. CN113400605 which uses an added heat source, allowing for much greater energy efficiency and faster cycling times.

In one embodiment, a heat pump system includes compressor 730 driven by motor 740. and electronic control unit 741 Electrically controlled valves 750 and 751 are operably connected to compressor 730. A low pressure cold line 760 runs from compressor 730 via valve 750 to electronically controlled valve 780 on mold section 320 for circulation through conduits 440. A low pressure hot line 770 runs from conduits 440 via valve 781 to valve 750 to compressor 730. A high pressure hot line runs from compressor 730 via vale 751 to the downstream end of barrel 65 and through electronically controlled valve 752 and returns via electronically controlled valve 753 and high pressure cold line 780 to valve 751. A storage tank 790 is connected to valve 751 and is used to store heat pump fluid when not in use and on a standby basis. Bypass sensors and digital control unit 741 is controls the heat pump system.

In operation, the heat pump system is not run continuously but rather synchronized with composite mixture mixing and injection molding operations. During a molding operation in the modular mold section 320, fluid in line 760 is circulated to the mold section 320 and back to compressor 730 to remove heat from modular mold section 320. During a composite mixture mixing operation in barrel 65, fluid is circulated, either from tank 790 or from line 770 to line 770. As fluid is circulated through line 770, it expels heat to barrel 65 and returns via line 780. When modular mold section 320 is in use, lines 760 and 770 are operated to circulate fluid to cool the mold chamber 421, while the lines 770 and 780 are not operated. In contrast, when auger screw 150 is operated, lines 770 and 780 are operated to heat barrel 65 and lines 760 and 770 are not operated. Control unit 741 controls the opening and closing of valves 750, 780, 781, 751, 752, and 753 as needed for such operations. Conventional heat pump fluid can be used in the heat pump system.

1. An injection molding apparatus comprising:
a barrel including an inlet in the barrel for receiving a molding composite mixture;
an outlet in the barrel for ejecting the composite mixture to a downstream portion of the apparatus;
the barrel further containing a screw wherein the screw includes a first set of flights and a second set of flights downstream from the first set of flights, wherein the first set of flights is located proximate to the inlet and is configured to compact the composite mixture and the second set of flights is configured to mix the compacted composite mixture without further compacting the compacted composite mixture.

2. The apparatus of claim 1, wherein the spacing of the flights in the first set of flights is greater than the spacing on the second set of flights.

3. The apparatus of claim 2, wherein the pitch of the flights in the first set of flights is greater than the pitch of the flights in the second set of flights.

4. The apparatus of any one of claims 1 to 3, the barrel further comprising fins on the shaft of the screw which impart turbulence the composite mixture moving past the zone of the fins.

5. The apparatus of claim 4, wherein the fins are located proximate a downstream end of the screw.

6. The apparatus of any one of claims 1 to 5, further including a mold tooling in communication with the outlet of the barrel and a heat pump system operably connected to the mold tooling to draw heat from the mold tooling and connected to the barrel to impart heat to the barrel, the heat pump system further including a regulator for synchronizing the operation of the heat pump with a molding cycle and an auger cycle of the apparatus.

7. The apparatus of claim 6, wherein the molding tool further comprises modular components are changing molding pieces to make different mold pieces.

8. The apparatus of claim 7, wherein the cooling circuit of the heat pump system is operated during a molding cycle of the apparatus with the heating circuit of the heat pump system not operating, and wherein the heating circuit is operated during operation of the screw while the cooling circuit is not operated.

9. The apparatus of any one of claims 1 to 8, wherein the composite mixture comprises recycled plastic and recycled crushed aggregate material.

10. The apparatus of any one of claims 1 to 9, where the screw comprises at least two modular sections.

11. The apparatus of any one of claims 1 to 10, wherein the apparatus further includes a horizontally oriented injection tube aligned in parallel below the horizontally aligned barrel, and a molding chamber, the injection tube comprising multiple inlets and an outlet to the molding chamber, and wherein the barrel is movable in a reciprocating fashion along its longitudinal axis whereby the outlet of the barrel can be aligned with one of the inlets of the injection tube to permit filling of the injection tube with composite mixture from the barrel.

12. The apparatus of claim 11, wherein the barrel is mounted on rails for the reciprocating movement.

13. A method of molding a piece, comprising:
providing a barrel with a screw;
introducing a composite mixture in the barrel.
compacting the mixture in the upstream end of the screw, inducing turbulence in the downstream end of the screw, whereby mixing the mixture is achieved.

14. The method of claim 13, wherein the composite mixture comprises recycled plastic and recycled crushed aggregate material.

15. The method of claim 14, further comprising forming a molded piece by injecting downstream of the screw the mixed mixture into a mold and further including extracting heat from the mold to cool the molded piece by using a heat pump system and circulating the extracted heat to the barrel to heat the composite mixture in the barrel, wherein the heat pump system is selectively operated to extract heat only when a molded piece is being formed and heat the barrel only when the screw is operated.
